(19) United States
(12) Patent Application Publication
(10) Pub. No.: US 2015/0156644 A1
(43) Pub. Date: Jun. 4, 2015

(54) DATA TRANSMISSION SYSTEM AND DATA TRANSMISSION METHOD

(71) Applicant: SAMSUNG ELECTRO-MECHANICS CO., LTD., Suwon-Si (KR)

(72) Inventor: Dong Won LEE, Suwon-Si (KR)

(73) Assignee: SAMSUNG ELECTRO-MECHANICS CO., LTD., Suwon-Si (KR)

(21) Appl. No.: 14/281,285

(22) Filed: May 19, 2014

(30) Foreign Application Priority Data
Nov. 29, 2013 (KR) 10-2013-0147095

(51) Int. Cl. H04W 24/04; H04W 4/00; H04W 40/24

(52) U.S. Cl. CPC H04W 24/04; H04W 40/244; H04W 4/006; H04W 84/18

(57) ABSTRACT

A data transmission system may inclulde: a plurality of nodes receiving channel information from a server, wherein a node, among the plurality of nodes, failing to receive the channel information, may receive the channel information from synchronizable nodes among nodes receiving the channel information. At least one node having a communications state with the server which does not satisfy preset conditions receives the channel information from the synchronizable nodes among the nodes receiving the channel information.

### CROSS-REFERENCE TO RELATED APPLICATION

This application claims the benefit of Korean Patent Application No. 10-2013-0147095 filed on Nov. 29, 2013, with the Korean Intellectual Property Office, the disclosure of which is incorporated herein by reference.

### BACKGROUND

The present disclosure relates to a data transmission system and a data transmission method.

Devices able to be used in a wireless sensor network commonly include a function of collecting a type of data that a server desires and accurately providing it to the server.

The ZigBee communications standard, a wireless sensor network technology, is a communications standard relating to a wireless network for data transmissions in the 2.4 GHz frequency band, and is characterized by low power consumption, low cost, and low speed. The ZigBee communications may be implemented through 1 to N communications by repeating radio packet transmissions and receptions using routing technology and may allow for a server to communicate with devices separated from the server by a predetermined distance or more.

However, end devices, positioned at a point having difficulty in making connection with an external power supply, may have has a poor communications environment with the server, such that it may be difficult to secure communications reliability.

That is, in the case in which the end devices fail to perform normal communications with the server due to a poor communications environment, the end devices require a new joining process, thereby causing a problem in which the end devices may require an excessively long time to be awoken. In addition, as most of the end devices are disposed in locations in which external power is not present or is not able to be supplied, the charge of a battery may be rapidly consumed.

The following Related Art Document (Patent Document 1) relates to a device and a method of sensing abnormality of a remote terminal using a sensor network. Patent Document 1 discloses that an end device including a sensor function provides information on network failures, disconnections, and the like to a server, to sense normality or abnormality of a terminal. Unlike the present disclosure, however, Patent Document 1 fails to disclose that a node having abnormal communications state with respect to the server may stably receive data by using peripheral nodes having normal communications state with respect to the server as a repeater.

### RELATED ART DOCUMENT

(Patent Document 1) Korean Patent Laid-Open Publication No. 2013-0090657

### SUMMARY

An aspect of the present disclosure may provide a data transmission system and a data transmission method capable of receiving channel information by performing, by a node having an abnormal communications state with a server, synchronization with peripheral nodes having a normal communications state with the server, and performing an update by verifying whether or not the update has been performed.

According to an aspect of the present disclosure, a data transmission system may include: a plurality of nodes receiving channel information from a server, wherein a node, among the plurality of nodes, failing to receive the channel information, may receive the channel information from synchronizable nodes among nodes receiving the channel information.

At least one node having a communications state with the server which does not satisfy preset conditions may receive the channel information from the synchronizable nodes among the nodes receiving the channel information.

The node failing to receive the channel information may be shifted to a sleep mode during a preset period when the synchronizable nodes are not present.

The plurality of nodes may include: a wireless communications unit receiving the channel information from the server; a controlling unit determining whether a communications state with the server satisfies preset conditions; and a memory unit storing the preset conditions and the channel information, and the controlling unit may receive the channel information from a node having a highest received signal strength indication (RSSI) among the synchronizable nodes.

The channel information may include a communications period with the server, communications channel information of the server, and update information of the plurality of nodes.

The node failing to receive channel information may perform wireless communications with the server by adjusting a preset period according to the communications period with the server.

According to another aspect of the present disclosure, a data transmission system may include: a plurality of nodes receiving a channel information from a server to be shifted to a first state when a communications state with the server satisfies preset conditions and to be shifted to a second state when the communications state with the server does not satisfy the preset conditions, wherein a second state node among the plurality of nodes may receive the channel information from a node having a highest received signal strength indication (RSSI) among one or more first state nodes within a preset distance.

The second state node may be synchronized with the node having the highest received signal strength indication by a wireless communications method.

The second state node may adjust a preset period according to communications period information of the server included in the channel information and receive the channel information from the server.

The plurality of nodes may include: a wireless communications unit receiving channel information from the server; a controlling unit determining whether the communications state with the server satisfies the preset conditions; and a memory unit storing the preset conditions and the channel information, and the controlling unit may shift a node to the first state when the communications state with the server satisfies the preset conditions and may shift a node to the second state when the communications state with the server does not satisfy the preset conditions.

The second state node may receive the channel information from a node having a second-highest received signal strength indication (RSSI) among the one or more first state nodes when the second state node fails to receive the channel information from the node having the highest received signal strength indication (RSSI).

According to another aspect of the present disclosure, a data transmission method may include: receiving, by a plurality of nodes, channel information from a server to determine whether a communications state with the server satisfies preset conditions; shifting a node to a first state when the communications state with the server satisfies the preset conditions and shifting a node to a second state when the communications state with the server does not satisfy the preset conditions; searching, by a second state node, one or more first state nodes within a preset distance; and receiving, by the second state node, the channel information from the first state node when the first state node is present within the preset distance.

The searching of the one or more first state nodes may include shifting the second state node to a sleep mode during a preset period when the first state node is not present in the preset distance.

The second state node may receive the channel information from a node having a highest received signal strength indication among the one or more first state nodes within the preset distance.

The data transmission method may further include adjusting, by the second state node, a preset period according to communications period information of the server included in the channel information.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a diagram illustrating a data transmission system according to an exemplary embodiment of the present disclosure;

FIG. 2 is a block diagram illustrating an example of a node illustrated in FIG. 1;

FIG. 3 is a diagram illustrating data included in channel information according to an exemplary embodiment of the present disclosure;

FIG. 4 is a diagram illustrating an operation of a data transmission system according to an exemplary embodiment of the present disclosure;

FIG. 5 is a diagram illustrating an operation of selecting an node providing channel information in the data transmission system illustrated in FIG. 4; and

FIG. 6 is a flowchart illustrating a data transmission method according to an exemplary embodiment of the present disclosure.

### DETAILED DESCRIPTION

Hereinafter, embodiments of the present disclosure will be described in detail with reference to the accompanying drawings.

The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art.

Throughout the drawings, the same or like reference numerals will be used to designate the same or like elements.

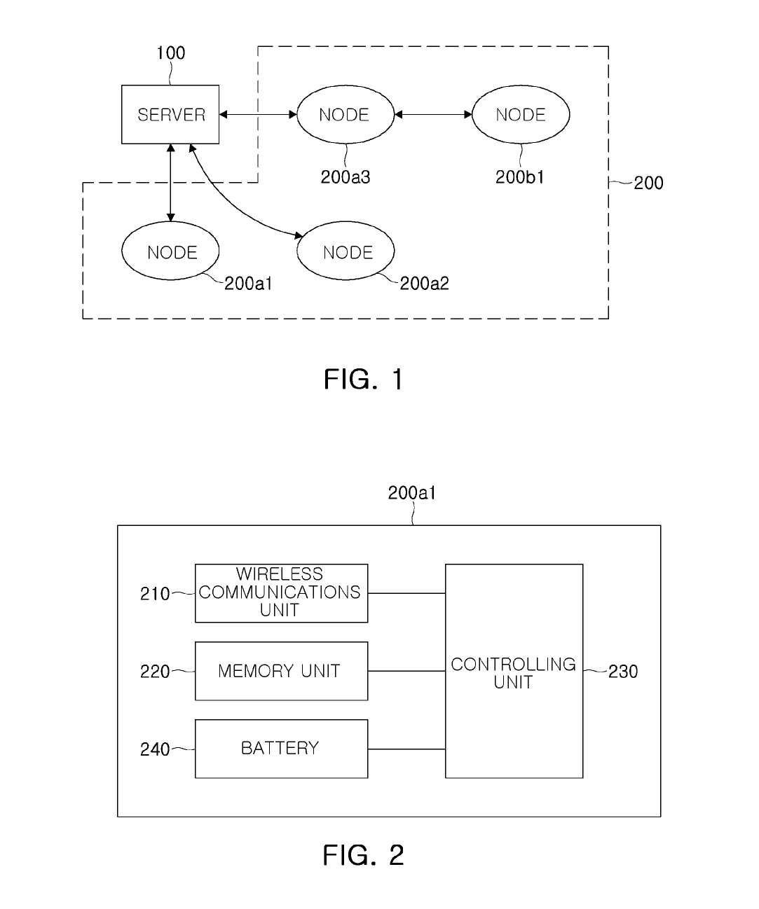

FIG. 1 is a diagram illustrating a data transmission system according to an exemplary embodiment of the present disclosure.

Referring to FIG. 1, a data transmission system according to an exemplary embodiment of the present disclosure may include a server 100 and a plurality of nodes 200.

The server 100 may transmit data to and receive data from the plurality of nodes 200, respectively. In this case, data may be channel information.

The plurality of nodes 200 may receive the channel information from the server 100. However, nodes, among the plurality of nodes 200, failing to receive channel information may receive the channel information from synchronizable nodes.

More specifically, each of the plurality of nodes 200 may first verify a communications state with the server 100. That is, any one node 200b1 of the plurality of nodes 200 may be in an abnormal communications state with the server 100. In this case, the abnormal communications state refers to a case in which the channel information is not received from the server 100 or only a portion of packets forming the channel information is received.

In this case, according to the related art data transmission system, the node 200b1 may have a long waiting time until it is woken up during a next period, thereby increasing battery consumption. In addition, the server may not also provide update information to the node 200b1.

Therefore, in the data transmission system according to the exemplary embodiment of the present disclosure, the node 200b1 may determine whether the synchronizable node is present among peripheral nodes 200a1 to 200a3 normally performing communications with the sever 100. If the synchronizable node 200a3 is present, the node 200b1 may receive the channel information from the synchronizable node 200a3.

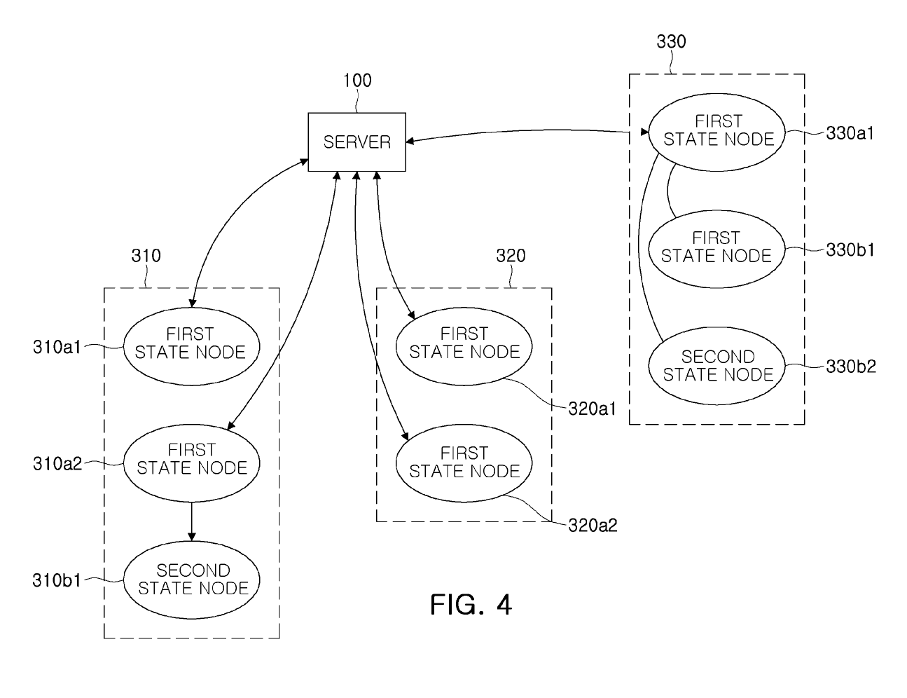

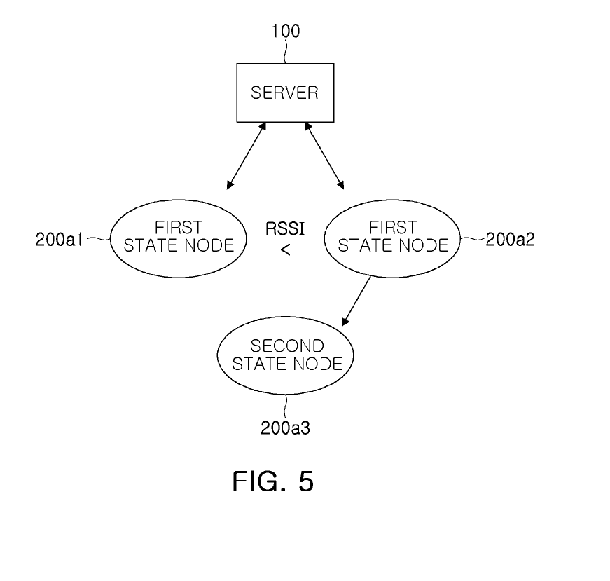

Meanwhile, if the synchronizable node is not present around the node 200b1, the node 200b1 may be shifted to a sleep mode during a next period, that is, a preset period, to wait. A detailed description thereof will be provided below with reference to FIGS. 4 and 5.

FIG. 2 is a block diagram illustrating an example of the node 200a1 illustrated in FIG. 1.

One node 200a1 among the plurality of nodes 200 may include a wireless communications unit 210, a memory unit 220, a controlling unit 230, and a battery 240.

The wireless communications unit 210 may receive the channel information from the server 100 using a preset wireless communications method. In this case, the preset wireless communications method may be ZigBee communications.

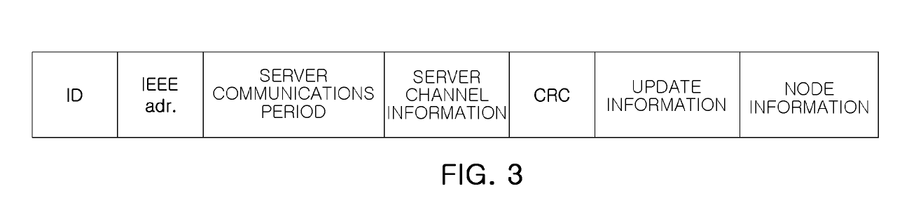

The controlling unit 230 may determine whether a communications state with the server 100 satisfies preset conditions. This operation may be performed by using cyclic redundancy check (CRC; error detecting code, see FIG. 3) included in the channel information. Meanwhile, the controlling unit 230 may receive the channel information from a node having the highest received signal strength indication (RSSI) among the synchronizable nodes.

The memory unit 220 may store preset conditions capable of verifying the communications state with the server 100. In addition, the memory unit 220 may store the channel information provided from the server 100.

FIG. 3 is a diagram illustrating data included in channel information according to an exemplary embodiment of the present disclosure.

Referring to FIG. 3, the channel information may include an IEEE address of the server 100, a PAN ID, a communications period of the server 100, and server channel information. In addition, the channel information may include the CRC (error detecting code) for determining the communications state with the server 100 and may also include update information of the corresponding node and node information of the synchronized node.

Hereinafter, a data transmission system and a data transmission method according to an exemplary embodiment of the present disclosure will be described in detail with reference to FIGS. 4 through 6.

FIG. 4 is a diagram illustrating an operation of the data transmission system according to an exemplary embodiment of the present disclosure.

FIG. 5 is a diagram illustrating an operation of selecting a node providing channel information in the data transmission system of FIG. 4.

Referring to FIGS. 1 and 4, the server 100 may provide the channel information to the plurality of nodes 200, respectively. Here, referring to FIG. 4, a preset number of adjacent nodes among the plurality of nodes 200 may be grouped. For example, the plurality of nodes 200 may be identified as a first group node 310, a second group node 320, and a third group node 330.

In this case, each of the plurality of nodes 200 may verify a communications state with the server 100 by receiving channel information from the server 100. Here, in the case in which the communications state with the server 100 satisfies preset conditions, the node may be shifted to a first state. In the case in which the communications state with the server 100 does not satisfy the preset conditions, the node may be shifted to a second state.

Therefore, referring to FIG. 4, the first group node 310 may be classified into first state nodes 310a1 and 310a2 having a communications state with the server 100 satisfying the preset conditions and a second state node 310b1 having a communications state with the server 100 which does not satisfy the preset conditions, and respective nodes included in the third group node 330 may be classified in the same manner as the first group node 310. However, all of nodes 320a1 and 320a2 included in the second group node 320 are assumed to have a communications state with the server 100 satisfying the preset conditions.

Next, the second state node 310b1 included in the first group node 310 may search one or more first state nodes 310a1 and 310a2 which are within a preset distance. In this case, the second state node 310b1 included in the first group node 310 may be synchronized with the node having the highest received signal strength indication (RSSI) among the first state nodes 310a1 and 310a2.

Further, the second state node 310b1 receives the channel information from a node having a second-highest received signal strength indication (RSSI) among the one or more first state nodes when the second state node fails to receive the channel information from the node having the highest received signal strength indication (RSSI).

A detailed description thereof will be provided with reference to FIG. 5. In the case in which a plurality of first state nodes 200a1 and 200a2 are present within a distance close to a second state node 200a3, the second state node 200a3 may be synchronized with the node having the highest received signal strength indication (RSSI) among the plurality of first state nodes 200a1 and 200a2. That is, the second state node 200a3 may be synchronized with the first state node 200a2 in FIG. 5. After the second state node 200a3 is synchronized with the first state node 200a2, it may receive the channel information.

Referring back to FIG. 4, the second state node 310b1 and the first state node 310a2 are adjacent to each other, and accordingly, the first state node 310a2 has the received signal strength indication (RSSI) relatively higher than the first state node 310a1, whereby the second state node 310b1 may be synchronized with the first state node 310a2.

Next, the second state node 310b1 may receive the channel information from the first state node 310a2. After the second state node 310b1 receives the channel information, it may verify update information included in the channel information. As a result, if the update is required, the second state node 310b1 may adjust its own preset period according to communications period information of the server 100 to synchronize with the server 100.

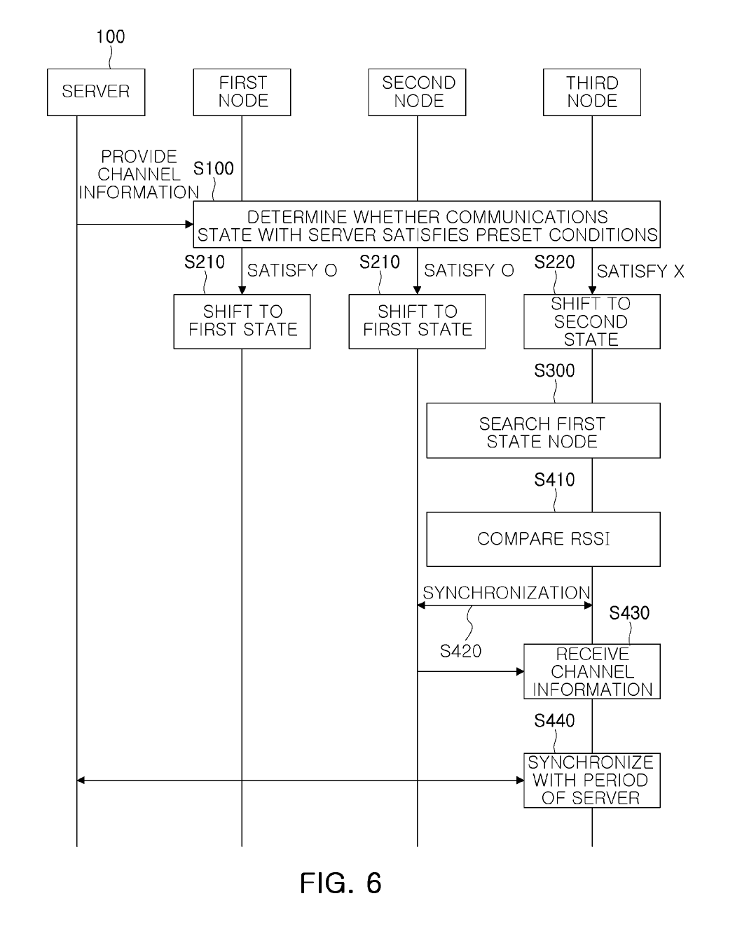

FIG. 6 is a flowchart illustrating a data transmission method according to an exemplary embodiment of the present disclosure.

A data transmission method according to an exemplary embodiment of the present disclosure will be described in detail with reference to FIG. 6. A plurality of nodes (e.g., first to third nodes in FIG. 6) may determine whether a communications state with a server 100 satisfies preset conditions (S100). This operation may be performed by using cyclic redundancy check (CRC) included in the received channel information.

Next, when a node of the plurality of nodes has a communications state with the server 100 satisfying the preset conditions, it may be shifted to a first state (S210), and when a node of the plurality of nodes has a communications state with the server 100 which does not satisfy the preset conditions, it may be shifted to a second state (S220). In FIG. 6, the first and second nodes may be shifted to the first state (S210) and the third node may be shifted to the second state (S220).

Next, the second state node (the third node) may search the first state nodes (the first and second nodes) which are within a preset distance (S300). Next, the third node may compare received signal strength indications (RSSIs) of the searched first state nodes (the first and second nodes) (S410). According to the comparison result, the second node having the highest received signal strength indication may be synchronized with the third node.

Next, the third node may receive channel information from the synchronized second node (S430). Next, the third node may determine whether or not the update is required by verifying update information included in the received channel information, and may synchronize a period thereof with a period of the server 100 by using period information of the server (S440).

That is, even in the case in which the third node has an abnormal communications state with the server 100, the third node may be synchronized with the second node having the highest RSSI among the first and second nodes having a normal communications state with the server 100 to thereby receive the channel information from the second node. Therefore, the third node may increase a communications success rate and decrease an update time and a wake-up time by sharing the channel information with the second node, thereby preventing a battery charge from being unnecessarily consumed.

As set forth above, according to exemplary embodiments of the present disclosure, a communications success rate may be increased by sharing communications between a server and individual nodes and between peripheral nodes having a normal communications state with the server, and an update time and a wake-up time may be decreased, whereby unnecessary battery consumption may be prevented.

While exemplary embodiments have been shown and described above, it will be apparent to those skilled in the art that modifications and variations could be made without departing from the spirit and scope of the present disclosure as defined by the appended claims.

What is claimed is:

1. A data transmission system, comprising:
a plurality of nodes receiving channel information from a server,
wherein a node, among the plurality of nodes, failing to receive the channel information, receives the channel information from synchronizable nodes among nodes receiving the channel information.

2. The data transmission system of claim 1, wherein at least one node having a communications state with the server which does not satisfy preset conditions receives the channel information from the synchronizable nodes among the nodes receiving the channel information.

3. The data transmission system of claim 1, wherein the node failing to receive the channel information is shifted to a sleep mode during a preset period when the synchronizable nodes are not present.

4. The data transmission system of claim 1, wherein the plurality of nodes includes:
a wireless communications unit receiving the channel information from the server;
a controlling unit determining whether a communications state with the server satisfies preset conditions; and
a memory unit storing the preset conditions and the channel information, and
the controlling unit receives the channel information from a node having a highest received signal strength indication (RSSI) among the synchronizable nodes.

5. The data transmission system of claim 1, wherein the channel information includes a communications period with the server, communications channel information of the server, and update information of the plurality of nodes.

6. The data transmission system of claim 5, wherein the node failing to receive the channel information performs wireless communications with the server by adjusting a preset period according to the communications period with the server.

7. A data transmission system, comprising:
a plurality of nodes receiving a channel information from a server to be shifted to a first state when a communications state with the server satisfies preset conditions and to be shifted to a second state when the communications state with the server does not satisfy the preset conditions,
wherein a second state node among the plurality of nodes receives the channel information from a node having a highest received signal strength indication (RSSI) among one or more first state nodes within a preset distance.

8. The data transmission system of claim 7, wherein the second state node is synchronized with the node having the highest received signal strength indication by a wireless communications method.

9. The data transmission system of claim 8, wherein the second state node adjusts a preset period according to communications period information of the server included in the channel information and receives the channel information from the server.

10. The data transmission system of claim 7, wherein the plurality of nodes includes:
a wireless communications unit receiving the channel information from the server;
a controlling unit determining whether the communications state with the server satisfies the preset conditions; and
a memory unit storing the preset conditions and the channel information, and
the controlling unit shifts anode to the first state when the communications state with the server satisfies the preset conditions and shifts a node to the second state when the communications state with the server does not satisfy the preset conditions.

11. The data transmission system of claim 7, wherein the second state node receives the channel information from a node having a second-highest received signal strength indication (RSSI) among the one or more first state nodes when the second state node fails to receive the channel information from the node having the highest received signal strength indication (RSSI).

12. A data transmission method, comprising:
receiving, by a plurality of nodes, channel information from a server to determine whether a communications state with the server satisfies preset conditions;
shifting a node to a first state when the communications state with the server satisfies the preset conditions and shifting a node to a second state when the communications state with the server does not satisfy the preset conditions;
searching, by a second state node, one or more first state nodes within a preset distance; and
receiving, by the second state node, the channel information from the first state node when the first state node is present within the preset distance.

13. The data transmission method of claim 12, wherein the searching of the one or more first state nodes includes shifting the second state node to a sleep mode during a preset period when the first state node is not present in the preset distance.

14. The data transmission method of claim 13, wherein the second state node receives the channel information from a node having a highest received signal strength indication among the one or more first state nodes within the preset distance.

15. The data transmission method of claim 12, further comprising adjusting, by the second state node, a preset period according to communications period information of the server included in the channel information.
